(19) United States
(12) Patent Application Publication
(10) Pub. No.: US 2024/0425338 A1
(43) Pub. Date: Dec. 26, 2024

(54) ELEVATED BASE FOR A JACK

(71) Applicant: Stewart Thompson, Strathmore (AU)

(72) Inventor: Stewart Thompson, Strathmore (AU)

(21) Appl. No.: 18/685,620

(22) PCT Filed: Aug. 24, 2022
(86) PCT No.: PCT/AU2022/050991

§ 371 Date: Feb. 22, 2024

(30) Foreign Application Priority Data
Aug. 24, 2021 (AU) 2021902708
Feb. 4, 2022 (AU) 2022900221

(51) Int. Cl. B66F 13/00; F16M 11/22

(52) U.S. Cl. CPC B66F 13/00; F16M 11/22; F16M 2200/08

(57) ABSTRACT

The present invention relates generally to a base support for a jack, and in particular, to a base support for a jack that elevates the jack above a support surface to extend the lifting height of the jack.

### RELATED APPLICATIONS

The present application claims priority from Australian Provisional Patent Application No. 2021902708 filed 24 Aug. 2021 and Australian Provisional Patent Application No. 2022900221 filed 4 Feb. 2022, the entire contents of which are incorporated herein by reference.

### FIELD OF INVENTION

The present invention relates generally to a base support for a jack, and in particular, to a base support for a jack that elevates the jack above a support surface to extend the lifting height of the jack.

### BACKGROUND OF THE INVENTION

Off-road vehicles, such as 4WD vehicles, are becoming increasingly popular as more people embrace outdoor recreation activities. As a direct result of this, many remote destinations that had previously been considered too difficult to access are becoming more accessible as off-road vehicles become more popular and developments in such vehicles to handle difficult terrain become realised.

In this regard, many 4WD vehicle owners seek to modify their vehicle to lift the suspension to increase the ride height and the clearance of the vehicle to improve the ride experience, especially in relation to the ability to negotiate more difficult terrain. Many vehicle owners may also seek to upgrade the Gross Vehicle Mass (GVM) to increase the maximum legal weight that is permitted for a fully loaded vehicle. To do this, GVM upgrade kits are available that alter the suspension of the vehicle by lifting the suspension to cater for increased load weight of the vehicle. Irrespective of the reason, many 4WD vehicles have a lifted suspension or use bigger tyres that add height to the vehicle such that the height of the vehicle is generally above the height of the vehicle when it was originally manufactured.

As a result if this increase in height of the vehicle, the jack that was originally supplied with the vehicle may no longer be useful. Should the user seek to use the jack to change a tyre, the lift of the jack may not be enough to safely raise the vehicle to the desired height to raise the wheel off the ground for it to be changed. As a result, the vehicle owner may be tempted to use the jack at a different point on the vehicle, other than the recommended jacking point, or may attempt to use the jack at a height beyond the recommended height limit of the jack. This can result in the vehicle and/or jack becoming unstable, significantly compromising the safety of the user and causing potential damage to the vehicle.

Whilst base units for jacks have been proposed, such units have generally been directed towards increasing the surface area of the jack for stability purposes, rather than elevating the jack to a desired level that can accommodate the increased height of the vehicle.

Thus, there is a need to provide for a base unit for use with a jack that can elevate the jack to a desired height to be effectively used with a vehicle and which maintains safety and stability of the jack during use.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

Accordingly, in one aspect of the invention there is provided a base unit for a jack comprising:
a body having a central portion and at least one lateral portion extending from the central portion;
wherein the central portion has a support surface elevated above a base of the body, the support surface configured to provide a surface for supporting the jack thereon such that the jack is usable in an elevated position.

In one embodiment, the support surface may be recessed below a peripheral wall.

The peripheral wall may have at least one recess formed therein.

An extension member may be configured to be received upon the support surface to be snugly received within the peripheral wall thereof, and wherein the extension member has at least one tab member that is received within the at least one recess formed in the peripheral wall to securely locate the extension member in position on the central portion.

The extension member may have an upper surface configured to support a jack thereon for use, such that when the extension member is positioned on the central portion the height of the jack is further elevated.

According to another aspect of the present invention, there is provided a base unit for a jack comprising:
a main body portion having a base and a support surface elevated above said base;
an extension member configured to be mounted on the support surface of the main body portion, the extension member having an upper surface configured to provide a surface for supporting the jack thereon;
wherein, the support surface of the main body portion is shaped to engage with an undersurface of the extension member to secure the extension member in position on the main body portion.

In one embodiment of this aspect, the upper surface of the extension member is configured to receive an insert mat upon which the jack is supported on.

The upper surface of the extension member may have a recess shaped to conform to a shape of the insert mat. The insert mat may be configured to accommodate any one or a plurality of jacks.

### BRIEF DESCRIPTION OF THE DRAWINGS

The invention may be better understood from the following non-limiting description of preferred embodiments, in which:

FIG. 1 is a perspective view of a base unit for a jack in accordance with one embodiment of the present invention;

FIG. 2 is a perspective view of an underside of the base unit of FIG. 1;

FIG. 3 is a perspective view of the base unit of FIG. 1 in use;

FIG. 4 is a perspective view of a base unit for a jack in accordance with another embodiment of the present invention;

FIG. 5 is an exploded view of the base unit of FIG. 4 in use;

FIG. 6 is a perspective view of the base unit of FIG. 4 in use

FIG. 7 is a perspective view of a base unit in accordance with yet another embodiment of the present invention;

FIG. 8 is an exploded view of the base unit of FIG. 7;

FIG. 9 is a top view of the base unit of FIG. 7; and

FIG. 10 is a bottom view of the base unit of FIG. 7

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The base unit of the present invention will be described below in relation to its application in elevating and supporting a jack for lifting a 4WD vehicle. However, it will be appreciated that the base unit of the present invention could be used to elevate and support a variety of different types of jacks for elevating a variety of different vehicles and equipment as will be appreciated by those skilled in the art.

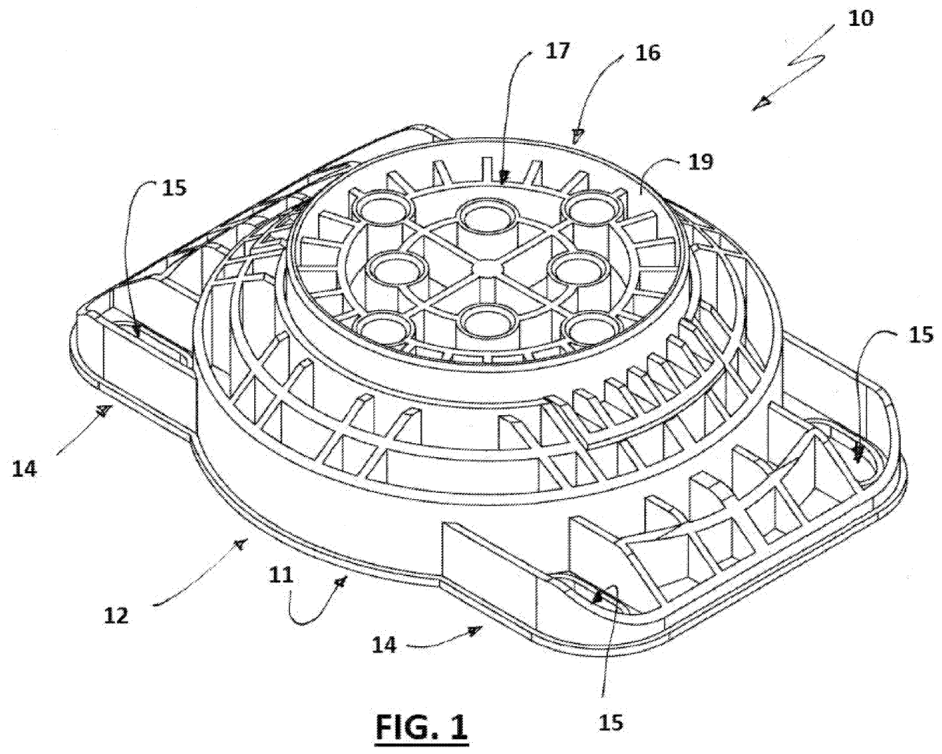

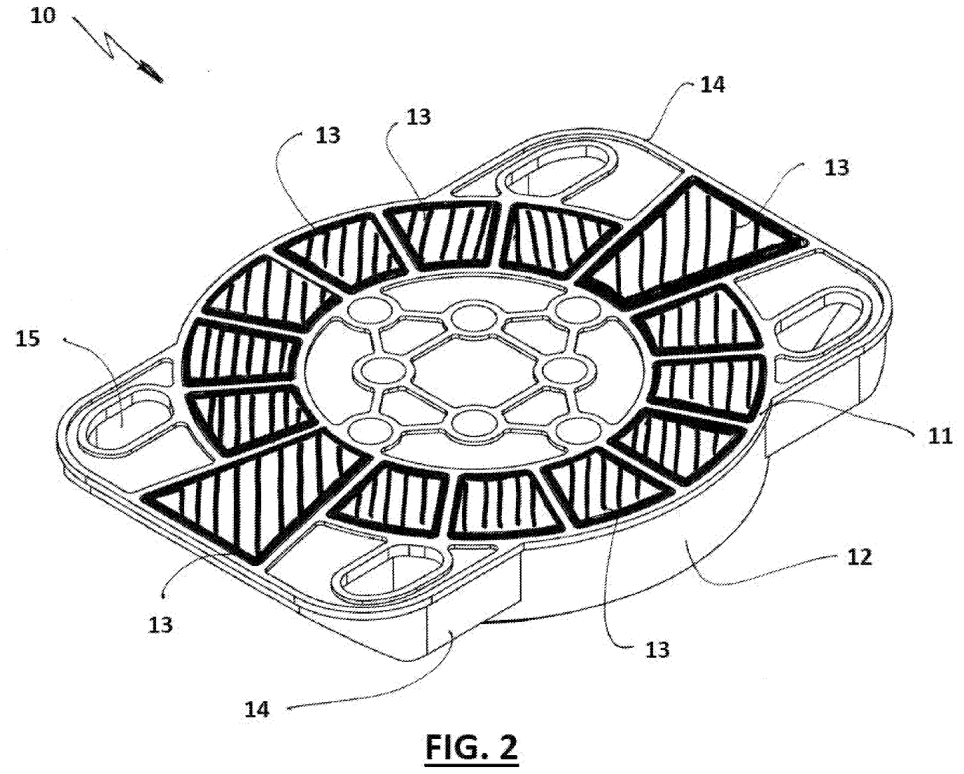

Referring to FIG. 1 and FIG. 2, a base unit 10 is depicted in accordance with an embodiment of the present invention. The base unit 10 is in the form of a body having a central portion 12 formed integrally with a pair of wings 14 extending laterally from opposing sides of central portion 12. The central portion 12 is elevated above the wings 14 and has a substantially circular configuration with a mounting portion 16 centrally located therein. The mounting portion 16 also has a circular configuration that defines a support surface 17 that is recessed below the upper surface of the central portion 12. A wall or rim 19 extends about the recessed support surface 17 as shown. Whilst two wings 14 are depicted, only one wing may be provided to perform the desired stability control function.

The underside 11 of the base unit 10 is shown in FIG. 2 and comprises a substantially flat surface with rubber inserts 13 formed therein to provide a non-slip surface for the base unit 10.

The wings 14 have recesses 15 formed therein. The recesses 15 extend through the wings 14 and provide a means for securing the base unit 10 to a ground surface with pegs or similar ground penetrating members. This enables the base unit to be further stabilised for use, where required.

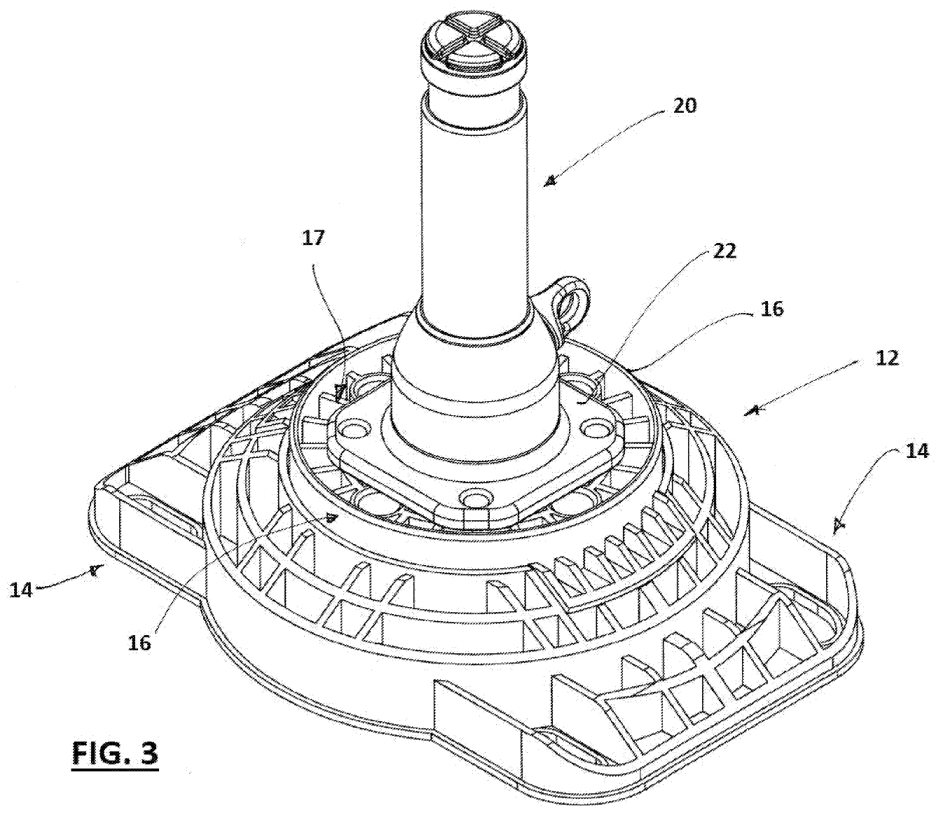

The base unit 10 is shown in use in FIG. 3 with a jack 20. As is shown, the base 22 of the jack 20 is supported on the support surface 17 of the central portion 12 such that it is elevated above the underlying ground surface at least 40 mm, to accommodate any lift of the chassis of the vehicle due to changes in suspension or increased tyre height. The wings 14 and central portion 12 support the jack over an extended surface area to accommodate any instability issues that may be present in the ground surface. In this arrangement, the jack 20 can be used in a conventional manner to elevate the vehicle chassis to change the vehicle's tyre or access the undercarriage of the vehicle as required.

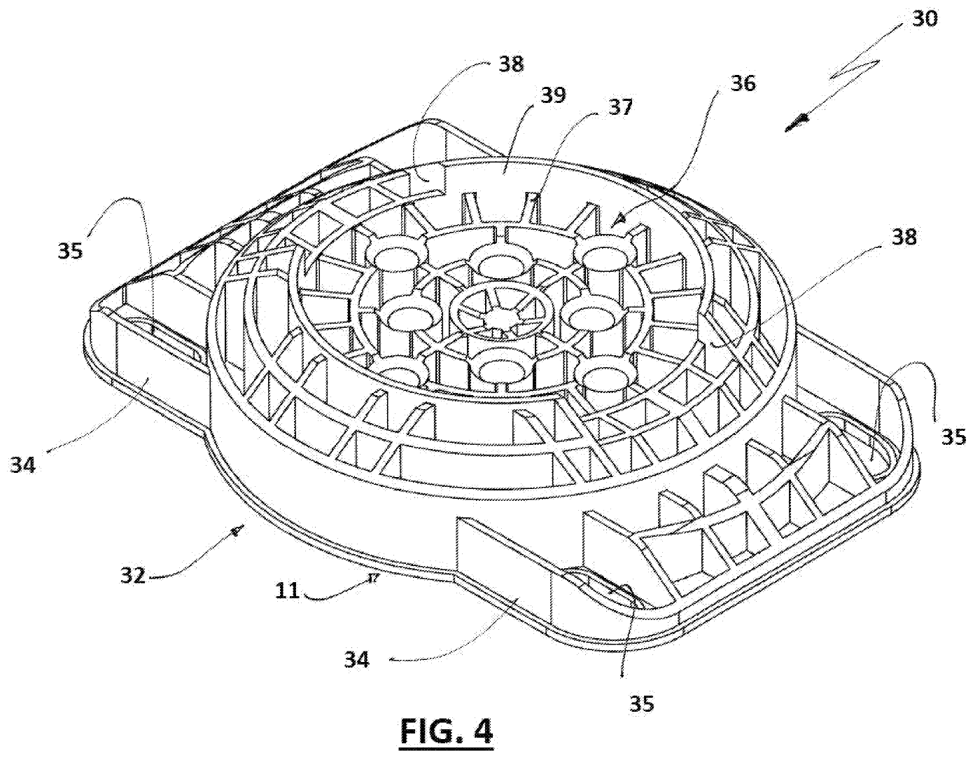

An alternative embodiment of a base unit 30 of the present invention is depicted in FIG. 4-FIG. 6. The base unit 30 is configured in a similar manner to base unit 10 of FIG. 1-FIG. 3 and comprises a body having a central portion 32 formed integrally with a pair of wings 34 extending laterally from opposing sides of central portion 32. The central portion 32 is elevated above the wings 32 and has a substantially circular configuration with a mounting portion 36 centrally located therein. The mounting portion 36 also has a circular configuration that defines a support surface 37 that is recessed below the upper surface of the central portion 32. A wall or rim 39 extends around the recessed support surface 37 as shown. The underside 31 of the base unit 30 is substantially the same as that shown in relation to the base unit 10 shown in FIG. 2.

The wings 34 have recesses 35 formed therein. The recesses 35 extend through the wings 34 and provide a means for securing the base unit 30 to a ground surface with pegs or similar ground penetrating members. This enables the base unit 30 to be further stabilised for use, where required.

However, the base unit 30 differs from base unit 10 in that the wall or rim 39 extending about the support surface 37 has a recess 38 formed therein at opposing sides thereof. The recess 38 in the wall or rim 39 are aligned at the same side of the central portion 32 as the wings 34.

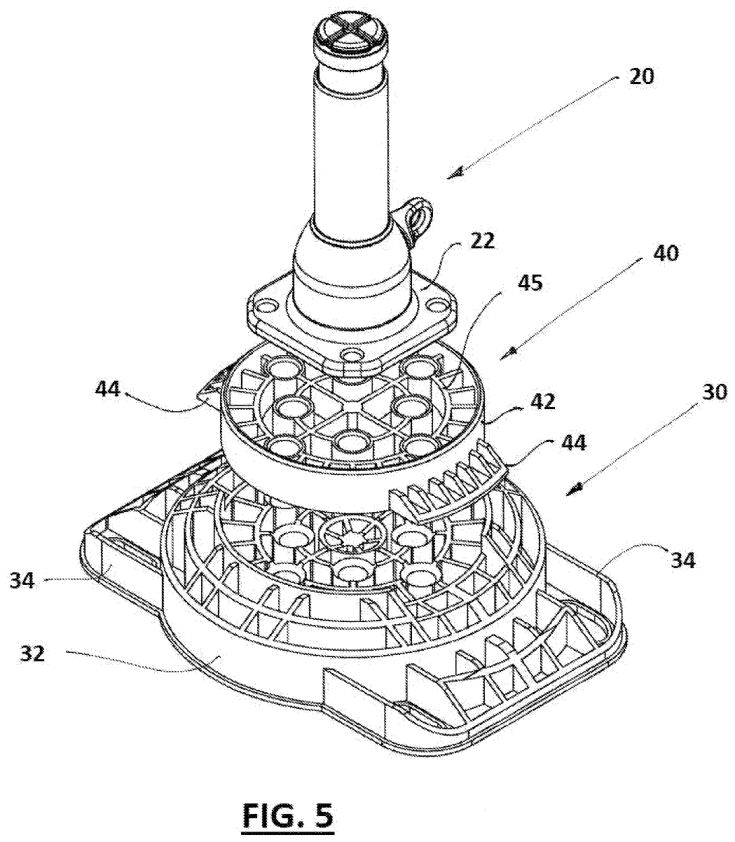

As is shown in FIG. 5, the recess 38 in the wall or rim 39 of the base unit 30 is provided to accommodate an extension member 40. The extension member 40 comprises a substantially disc shaped body 42 that is configured to snugly fit within the circular shape of the mounting portion 36. The extension member 40 has tab members 44 extending from opposing sides of the disc shaped body 42 that have a width substantially equivalent to the width of the recess 38 formed in the wall or rim 39 of the base unit 30. Therefore, when the extension member 40 is positioned within the mounting portion 36 of the base unit 30 it is snugly received by way of an interference fit thereby securely retaining the extension member 40 in position on the base unit 30.

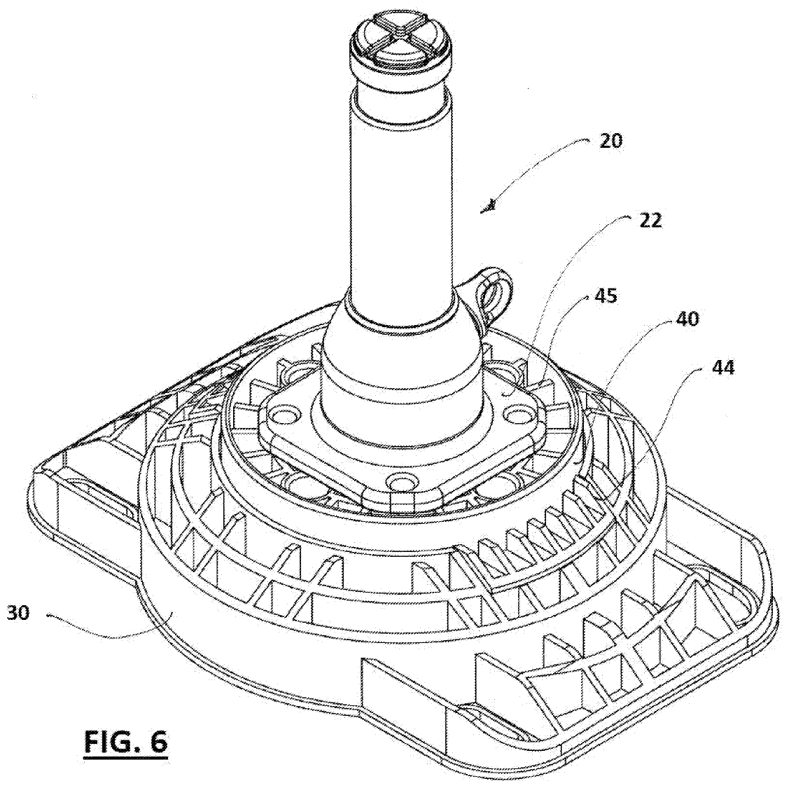

The upper surface 45 of the extension member 40 is substantially flat and is recessed below an upper edge or rim of the extension member and functions to provide a support surface for a jack 20, as is shown in FIG. 6.

It will be appreciated that the extension member 40 has a thickness that extends the overall height of the combined base unit 30 and the extension member 40 such that the jack 20 is elevated in a higher position for use. This can enable the jack 20 to be safely used with a vehicle that has been lifted to a level that will not enable the jack 20 to be used safely with only the base unit 30. It will also be appreciated that the base unit 30 could be used with or without the extension member 40, depending upon the height requirements for the jack.

The base unit 10, 30 may provide a height elevation for the jack of between of between 30-60 mm. The extension member 40 may provide a height elevation of between 20-40 mm such that in combination the base unit and extension member can provide elevation for jack of up to 100 mm.

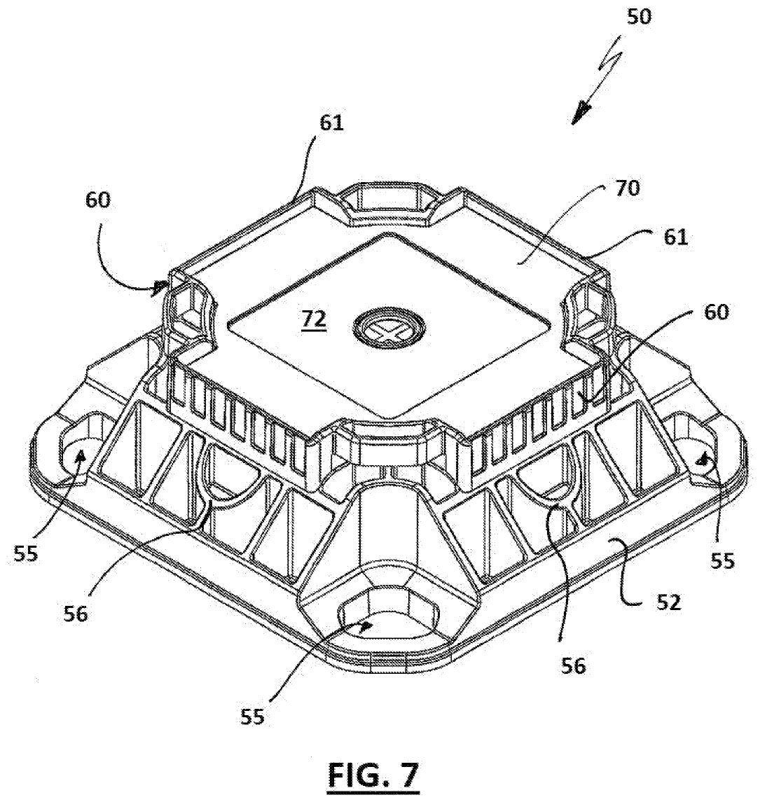

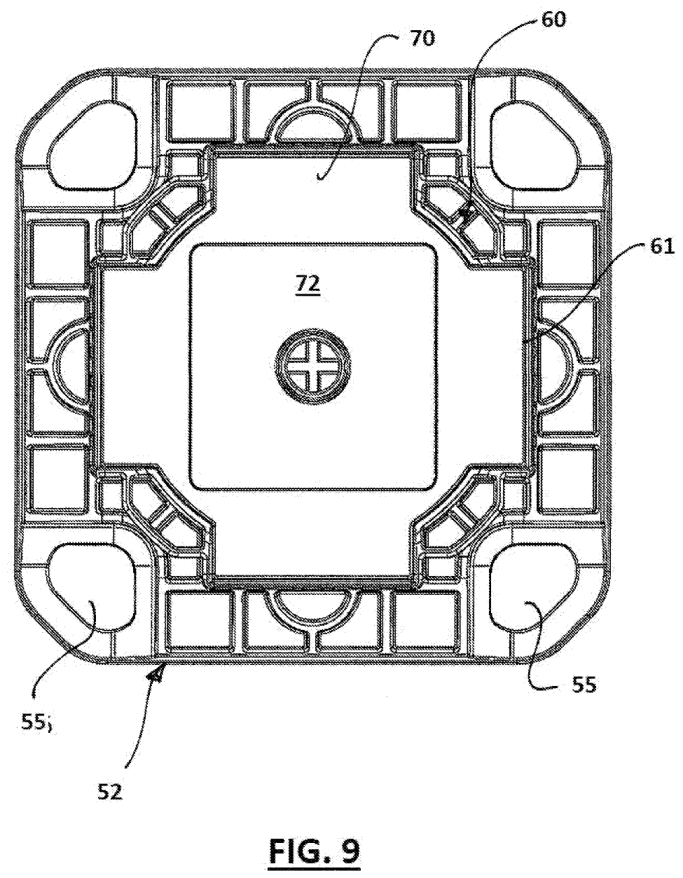

Yet another embodiment of a base unit 50 in accordance with the present invention is depicted in FIG. 7-FIG. 10.

In this embodiment, the base unit 50 comprises a main body portion 52 having a substantially rectangular shape.

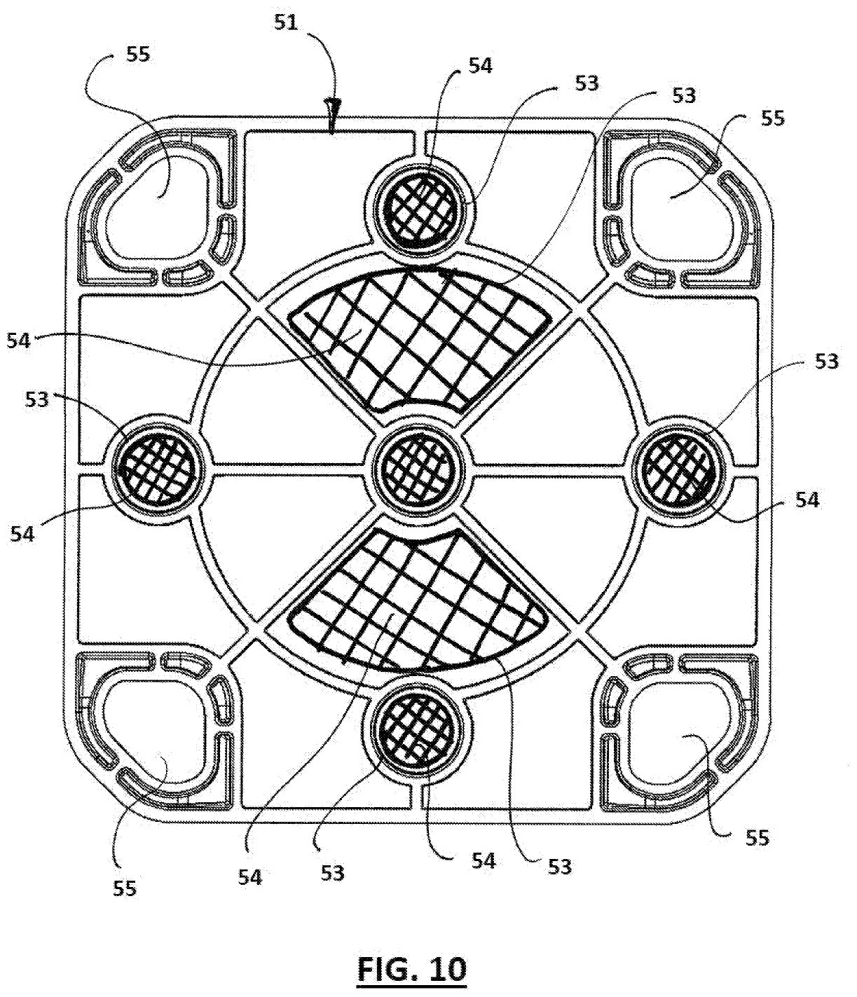

As seen more clearly in FIG. 10, the main body portion 52 has a substantially flat underside 51 that is configured to be placed upon a support surface, such as a ground surface or the like. The underside 51 has a plurality of indentations 53 formed therein. The indentations 53 are configured to receive gripping members 54 that are secured therein and project therefrom to provide a friction interface between the underside 51 of the main body portion 52 and the support surface. In a preferred embodiment the gripping members 54 are formed from a rubber material, although the gripping members 54 may be formed from any variety of materials and surface treated to provide such a gripping function.

A plurality of holes 55 are formed through the main body portion 52. In the embodiment as shown the holes 55 are provided at the corners of the main body portion 52 and provide a means by which pegs (not shown), or similar ground penetrating members, may be used to secure the main body portion 52 to the underlying support surface, such as a ground surface.

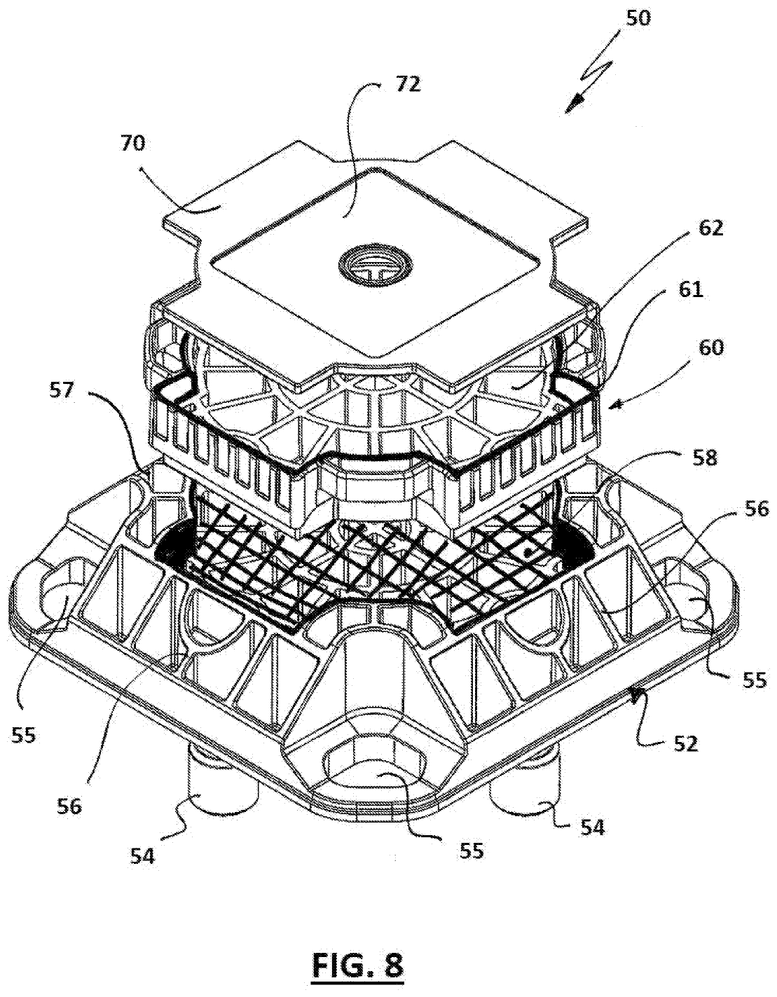

As can be seen more clearly in FIG. 8, the main body portion 52 has a substantially truncated pyramid shape, having angled side walls 56 terminating in a substantially flat upper surface 57. The corners of the main body portion 52 are recessed to provide access to the holes 55 to facilitate the use of pegs or similar ground penetrating members to secure the main body portion in position on a ground or support surface. The upper surface 57 has an inner recess 58 formed therein, depicted in FIG. 8 by the hashed lines, which creates a recessed surface upon which an extension member 60 is received and supported. The shape of the inner recess 58 is configured to accommodate the external shape of the extension member 60, as shown, to ensure that the extension member 60 is snugly received by the main body portion 52 and is securely retained in position atop the main body portion 52, in the manner as depicted in FIG. 7.

When positioned on the main body portion 52, the extension member 60 provides an elevated upper surface 62 that is recessed below an external lip 61 that extends about a perimeter of the upper surface 62, as is depicted by the bold line in FIG. 8. An insert mat 70 is configured to be positioned on the upper surface 62 of the extension member 60. The insert mat 70 is preferably made from a rubber material and is shaped to fit the shape of the upper surface 62 such that it is securely maintained in position thereon by the external lip 61.

The insert mat 70 may have an upper surface 72 that is adapted to accommodate different types of jacks. In this regard, the upper surface 72 of the insert mat 70 may have a recess formed therein to accommodate a base of a specific type of jack supplied for a specific type of vehicle. To adapt for use with different types of jacks, the insert mat 70 may be replaceable with different insert mats to accommodate different vehicle jacks, as required. Similarly, the insert mat 70 may be configured such that it provides a universal fit with a variety of existing jack configurations, based on the shape of the recess formed in the surface 72 thereof. The upper surface 72 of the insert mat 70 may be configured to have a recess or keyed shape provided therein to provide a positive lock with a jack to be used with the base unit 50, to increase stability of the jack. Similarly, the upper surface 72 of the insert mat 70 may also have a scallop shaped recess formed therein to accommodate a jockey wheel for a caravan or the like. Other shaped recesses may also be used to enable the base unit 50 to be used to support a variety of different components in an elevated position.

It will be appreciated that in alternative embodiments of this aspect of the invention, the upper surface of the main body portion 52 and/or the extension member 60 may have a stepped recess formed therein that is shaped to accommodate a base of a jack. In such an arrangement, there is no requirement for insert mat 70 as the base will be directly supported in the recess formed in the surface of the main body portion 52 and/or the extension member 60.

Whilst not shown, a plurality of extension members 60 may be employed with the base unit 50 to provide a stackable platform. As is depicted with the main body portion 52 and the extension member 60, each additional extension member 60 may also be configured to interlock with the underlying base member to ensure stability of the stackable platform. In such a configuration, the heights of the extension members 60 may vary to provide an overall end height sufficient to support and elevate a jack for safe use.

Whilst the extension members 60 are depicted as nesting within a lipped recess formed in the main body portion 52, the extension members 60 may be mechanically secured to the main body portion 52 or an underlying extension member 60. In this regard, one or more pins or fasteners (not shown) may be provided to provide such mechanical fastening between the components to ensure maximum stability for the jack.

It will be appreciated that the present invention provides a simple yet effective elevation system for use with an OE or manufactured supplied jack to enable the jack to be safely used with vehicles that have been raised in height. This avoids the need to purchase a replacement jack for use with such vehicles and ensures that the use of the jack will be safe and effective.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention.

I claim:

1. A base unit for a jack comprising:
a body having a central portion and at least one lateral portion extending from the central portion;
wherein the central portion has a support surface elevated above a base of the body, the support surface configured to provide a surface for supporting the jack thereon such that the jack is usable in an elevated position.

2. A base unit for a jack according to claim 1, wherein the base of the body has rubber inserts attached thereto to engage a ground surface supporting the body.

3. A base unit for a jack according to claim 1, wherein the support surface is recessed below a peripheral wall.

4. A base unit for a jack according to claim 3, wherein the peripheral wall has at least one recess formed therein.

5. A base unit for a jack according to claim 4, wherein an extension member is configured to be received upon the support surface to be snugly received within the peripheral wall thereof, and wherein the extension member has at least one tab member that is received within the at least one recess formed in the peripheral wall to securely locate the extension member in position on the central portion.

6. A base unit for a jack according to claim 5, wherein the extension member has an upper surface configured to support a jack thereon for use, such that when the extension member is positioned on the central portion the height of the jack is further elevated.

7. A base unit for a jack according to claim 6, wherein the upper surface of the extension member is configured to receive an insert member.

8. A base unit for a jack according to claim 7, wherein the insert member is in the form of a mat having a recess formed therein to nestingly receive a base of a jack thereon.

9. A base unit for a jack according to claim 6 wherein the upper surface of the extension member has a recess formed therein to nestingly receive a base of a jack thereon.

10. A base unit for a jack according to claim 5, wherein a plurality of extension members are configured to be received in a stacked manner upon the support surface.

11. A base unit for a jack comprising:
a main body portion having a base and a support surface elevated above said base;
an extension member configured to be mounted on the support surface of the main body portion, the extension member having an upper surface configured to provide a surface for supporting the jack thereon;
wherein, the support surface of the main body portion is shaped to engage with an undersurface of the extension member to secure the extension member in position on the main body portion.

12. A base unit according to claim 11, wherein the upper surface of the extension member is configured to receive an insert mat upon which the jack is supported on.

13. A base unit according to claim 12, wherein the upper surface of the extension member has a recess shaped to conform to a shape of the insert mat.

14. A base unit according to claim 12, wherein the insert mat is configured to accommodate any one or a plurality of jacks.

15. A base unit according to claim 11 wherein the upper surface of the extension member has a recess formed therein to receive a base of a jack thereon.

16. A base unit according to claim 11, wherein a plurality of extension members are configured to be received in a stacked manner upon the support surface.
